(19) United States
(12) Patent Application Publication
(10) Pub. No.: US 2003/0210865 A1
(43) Pub. Date: Nov. 13, 2003

(54) Method and apparatus for coupling of optically active devices to a planar lightwave circuit

(76) Inventor: Kjetil Johannessen, Trondheim (NO)

Correspondence Address: Jan Carol Little, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/142,145

(22) Filed: May 8, 2002

(51) Int. Cl. G02B 6/30; G02B 6/42; G02B 6/26; G02B 6/12

(52) U.S. Cl. 385/49; 385/88; 385/39; 385/14

(57) ABSTRACT

A planar lightwave circuit comprises several parallel adjacent waveguides with recessed area by reducing the thickness of an upper cladding layer such that a core of the waveguide is exposed at the recessed area. Optically active device arrays are coupled to the core of the waveguides through the recessed area without using the perimeter of the planar lightwave circuit. A refractive index of the optically active devices is higher than that of the waveguides such that the optically active device absorbs a light from the waveguides to monitor the channels of the waveguides. The optically active devices have several stripes running along the length of the waveguides, which are connected to the recessed area.

### BACKGROUND OF THE INVENTION

1. Technical Field

Embodiments of the invention relate to optical waveguide devices; and more specifically relate to an apparatus for monitoring traffic in a planar light wave circuit (PLC).

2. Background Information

An optical telecommunication network system transmits information from one place to another by way of a carrier whose frequency is in the visible or near-infrared region of the electromagnetic spectrum. A carrier with such a high frequency is sometimes referred to as an optical signal, an optical carrier, or a lightwave signal. An optical telecommunication system includes several optical fibers, each of which includes several channels. A channel is a specified frequency band of an electromagnetic signal, and is sometimes referred to as a wavelength. An optical telecommunication network that transmits more than one channel over the same optical fiber is sometimes referred to as a multiple channel system. The purpose for using multiple channels in the same optical fiber is to take advantage of the unprecedented capacity offered by optical fibers. Essentially, each channel has its own wavelength, and all wavelengths are separated enough to prevent overlap.

One way to transmit multiple channels is through wavelength division multiplexing (WDM), whereupon several wavelengths are transmitted in the same optical fiber. Typically, several channels are interleaved by a multiplexer, launched into the optical fiber, and separated by a demultiplexer at a receiver. Along the way, channels may be added or dropped using an add/drop multiplexer (ADM). Wavelength division demultiplexing elements separate the individual wavelengths using frequency-selective components such as optical gratings or bandpass filters.

One challenge faced in designing optical telecommunication networks is how to couple the optical signal into detectors, such as for monitoring network traffic flow, monitoring signal levels, and/or monitoring polarization states. In the prior art, monitoring of optical telecommunication networks may be done using dedicated side reflecting fiber Bragg gratings. Fiber Bragg gratings have low insertion loss, but are costly to manufacture.

Another prior art technique for monitoring of optical telecommunication networks uses planar lightwave circuits (PLC) with optical fiber attachments. PLCs with optical fiber attachments tend to have higher insertion loss than fiber Bragg gratings. PLCs with optical fiber attachments also tend to be costly to manufacture as well.

Still another prior art technique for monitoring of optical telecommunication networks uses PLCs with an edge mounted detector array. PLCs with an edge mounted detector arrays are precision aligned and mounted, which increases fabrication costs. Also, because the edge area of PLCs is valuable, edge mounted detector arrays that have a large number of fibers attached consume the edge area. Moreover, prior art output channels are spaced approximately 125 micrometers (125 μm) apart, which means that the PLC with edge mounted detector arrays must be large enough to accommodate 125 μm spacing. As WDM technology advances to allow an increasing number of channels to cope with increases in information volume, however, the size of such a PLC can be prohibitive.

Additionally, detectors like those used for side reflecting Bragg gratings and other applications tend to be relatively large and in many instances the light levels are low so that individual bits in the data stream normally become indistinguishable.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 is a perspective diagram showing a cross-sectional side view of a prior art photonic device;

FIG. 2 is a perspective diagram showing a cross-sectional top view of a photonic device according to embodiments of the present invention;

FIG. 3 is a perspective diagram showing a cross-sectional longitudinal view of the photonic device in FIG. 2 according to alternative embodiments of the present invention;

FIG. 4 is a schematic diagram showing a top view of a photonic device according to embodiments of the present invention;

FIG. 5 is a perspective diagram showing a cross-sectional side view of a photonic device according to embodiments of the present invention;

FIG. 6 is a flowchart illustrating an approach to fabricating a photonic device according to embodiments of the present invention;

FIG. 7 is a schematic diagram of an optical system according to embodiments of the present invention; and

FIG. 8 is a schematic diagram of an optical system according to embodiments of the present invention.

### DETAILED DESCRIPTION OF THE ILLUSTRATED EMBODIMENTS

Embodiments of a photonic device are described herein. In the following description, numerous specific details, such as particular processes, materials, devices, and so forth, are presented to provide a thorough understanding of embodiments of the invention. One skilled in the relevant art will recognize, however, that the invention can be practiced without one or more of the specific details, or with other methods, components, etc. In other instances, wellknown structures or operations are not shown or described in detail to avoid obscuring various embodiments of the present invention.

Some parts of this description will be presented using terms such as waveguide, silicon, and so forth. These terms are commonly employed by those skilled in the art to convey the substance of their work to others skilled in the art.

Various operations will be described as multiple discrete blocks performed in turn in a manner that is most helpful in understanding the invention. However, the order in which they are described should not be construed to imply that these operations are necessarily order dependent or that the operations be performed in the order in which the blocks are presented.

Reference throughout this specification to “one embodiment” or “an embodiment” means that a particular feature, structure, process, block, or characteristic described in connection with the embodiment of the present invention is included in at least one embodiment of the present invention. Thus, the appearances of the phrases “in one embodiment of the present invention” or “in an embodiment of the present invention” in various places throughout this specification are not necessarily all referring to the same embodiment of the present invention. Furthermore, the particular features, structures, or characteristics may be combined in any suitable manner in one or more embodiments of the present invention.

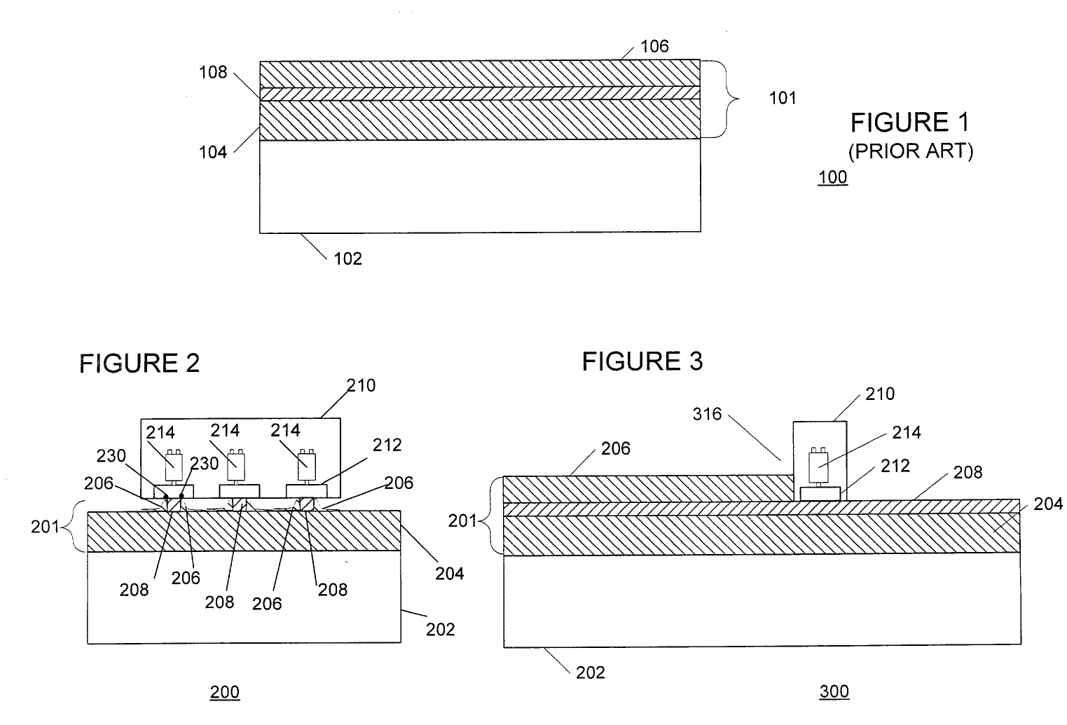

FIG. 1 is a perspective view of a prior art planar lightwave circuit (PLC) 100 that includes a waveguide 101 formed on a substrate 102. The waveguide 101 includes a lower cladding layer 104, an upper cladding layer 106, and a core 108.

FIG. 2 is a cross-sectional view of a photonic device 200 according to embodiments of the present invention. The photonic device 200 may include a planar lightwave circuit (PLC) manufactured using suitable semiconductor processing equipment. For example, the photonic device 200 may include a silica-on-silicon platform, a lithium niobate (LiNbO₃) platform, a gallium arsenide (GaAs) platform, an indium phosphide (InP) platform, a siliconon-insulator (SOI) platform, a silicon oxynitride (SiON) platform, a polymer platform, or other suitable planar lightwave circuit (PLC) platform.

The photonic device 200 may include a set of waveguides 201 formed on a substrate 202. The set of waveguides 201 may be single mode waveguides. Alternatively, the set of waveguides 201 may be multimode waveguides.

The set of waveguides 201 include a lower cladding layer 204 disposed on the substrate 202, a set of waveguide cores 208 is disposed on the lower cladding layer 204, and an upper cladding layer 206 disposed on the set of waveguide cores 208, which have been exposed by removing some of the upper cladding layer 206 such that the waveguide cores 208 protrude from the planar surface.

In one embodiment, the photonic device 200 also includes an optically active device array 210, which is disposed proximate to the exposed waveguide cores 208. The optically active device array 210 may be an array of semiconductor light detectors, optical modulators, or other suitable optically active devices.

The optically active device array 210 includes a set of active regions 212, which have a material that has a high index of refraction (e.g., higher than the index of refraction of the waveguide cores 208). The high index of refraction attracts light from the waveguide cores 208. In one embodiment, optically active device array 210 is in physical contact with exposed waveguide cores 208. In an alternative embodiment, the optically active device array 210 is not in physical contact with the exposed waveguide cores 208. Instead, the optically active device array 210 is in close proximity to the exposed waveguide cores 208.

In operation, when light is propagated through the waveguide cores 208 some of the light is coupled from the waveguide cores 208 into the optically active device array 210 via the active regions 212, to allow for monitoring of the light propagating in the waveguide cores 208, for example. Placing the active regions 212 in contact with exposed portions of the waveguide cores 208 allows light to be monitored without having to put the optically active device array 210 on the edges of the photonic device 200. As a result, the photonic device 200 is smaller, more elegant, and easier to handle than prior art devices. Additionally, the photonic device 200 is more efficient because light is directly coupled into the optically active device array 210 with no mode conversion loss and virtually no return loss.

In one embodiment of the present invention, light is gradually leaked from the waveguide cores 208 to the optically active device array 210. Generally, the coupling from the waveguide cores 208 to the optically active device array 210 is dependent on the difference in the index or refraction between the waveguide cores 208 and the optically active device array 210, the polarization or the light, and/or the remaining thinned upper cladding layer 206, each of which may be controlled. Light may be coupled from the waveguide cores 208 to the optically active device array 210 essentially as an exponential decay, whose length may be varied from a few tens of micrometers to several millimeters. Generally, using long decay lengths result in very low return loss.

The layer design and detector length may be varied to allow selectable coupling (e.g., from full detection to tap coupling) of the optical signal from the waveguide 208 to the optically active device array 210. The length of the decay and/or the length of the active regions 212 may be varied to vary the coupling efficiency from the waveguide cores 208 to the optically active device array 210. In one embodiment of the present invention, the active regions 212 are relatively long, which provides substantial detection of the data stream. For example, one or more active regions 212 may be approximately five hundred micrometers (500 μm) long and ten micrometers (10 μm) wide. In this and other embodiments, the width of any one of the waveguide cores 202 may be approximately three micrometers (3 μm).

In an alternative embodiment of the present invention, the active regions 212 are relatively short (e.g., a tap coupler), which extracts a portion of an optical signal from the waveguide 208 to provide less detection (e.g., approximately five percent) of the data stream. For example, one or more active regions 212 may be approximately one hundred micrometers (100 μm) long and ten micrometers (10 μm) wide. In this and other embodiments in which the active regions 212 are tap couplers, the tap couplers may be polarization dependent, with one polarization state absorbing more light than the other polarization state.

According to an embodiment of the present invention, a layer of silica (SiO₂) may be deposited on a silicon substrate to form the lower cladding layer 204 for the waveguide cores 208, using thermal oxidation, for example. A layer of doped silica may be deposited on the first layer of SiO₂ using flame hydrolysis deposition or chemical vapor deposition, for example, to form the waveguide cores 208. The amount and/or type of dopant may be varied to vary the refractive index of the waveguide cores 208. Dopants may include nitrogen (N), which may form an oxynitride when oxidized, titanium (Ti), or other suitable dopant. Another layer of silica (SiO₂) may be deposited on waveguide cores 208 to form the upper cladding layer 206 for the waveguide cores 208, using flame hydrolysis deposition, or chemical vapor deposition, for example.

The cores of the waveguide cores 208 may be exposed using chemical processes to remove all but selective portions of the upper cladding layer 206, by reactive ion etching, for example. The optically active device array 210 may be mounted (e.g., aligned and bonded) to the waveguide cores 208 and/or the upper cladding layer 206 using optically transparent glue or using well-known flip-chip technology. An index of refraction matching fluid also may be applied between the active regions 212 and the cores of the waveguide cores 208. Mounting may be implemented using any well-known wafer scale, high yield, low-cost process. Of course, the photonic device 200 may be fabricated using other standard semiconductor fabrication techniques, such as implantation, doping, evaporation, physical vapor deposition, ion assisted deposition, photolithography, magnetron sputtering, electron beam sputtering, masking, reactive ion etching, and/or other semiconductor fabrication techniques well known to those skilled in the art.

Optically active devices 214 are included in optically active device array 210 and may be avalanche photodiodes (APD), PIN photodiodes, charge coupled device (CCD) devices, photoconductors (e.g., thin single-crystal or polycrystalline film), or other suitable devices that detect light (or photons) and convert the light to an electrical signal, for example.

The active regions 212 may be larger in area than the area of the exposed waveguide cores 208 to reduce the amount of coupling. The active regions 212 also may include contacts or electrodes (230) to act as alignment guides for mounting and aligning the optically active device array 210 to the waveguide cores 208. In one embodiment, the contacts 230 may be optically dense so that the contacts 230 can be used as masks to reduce cross-talk between neighboring waveguide cores 208 and/or active regions 212 of the optically active devices 214. The alignment between the PLC and the optically active device chip is made easier and can also be physically guided and aligned (e.g. through flip-chip technology). The alignment tolerances may be relaxed and adapted to the fabrication precision of the array of optically active devices 214.

The index of refraction of the active regions 112 is much higher than the index of refraction of the waveguide cores 208. For example, the active regions 112 may include semiconductor material, such as germanium (Ge) or III-V material, such as indium gallium arsenide (InGaAs), and the like. Alternatively, the active regions 112 may include nitrogen (N), oxynitride (ON), more complex semiconductor materials, such as pyroelectric materials and/or microbolometers, or other suitable material. Generally, the refractive index of III-V material is much higher (n≅3.3−3.6) than the refractive index of typical planar lightwave circuits (n≅1.44−2). Semiconductor material is well known.

Alternatively, the optically active device array 210 does not have active regions. Instead, an active material may be deposited directly onto the cores of the waveguide cores 208 to couple light from the cores of the waveguide cores 208 into the optically active device array 210. In this embodiment of the present invention, the active material may include InGaAs in crystalline (if fabricated using epitaxial deposition).

When several waveguides are to be coupled to several optically active devices, the optically active device array 210 can be used to save edge area on the photonic device 200, for example, to use to mount electronics packages. As a result, the photonic device 200 is smaller, more elegant, and easier to handle than prior art devices. Additionally, the light monitoring process is more efficient because light is coupled directly into the optically active device array 210 surfaces from the surfaces of the cores of the waveguide cores 208. There is no mode conversion loss and virtually no return loss.

In one embodiment, the optically active device array 210 may directly monitor an optical signal propagating in the waveguide 201 by tapping a fraction of the light passing under the optically active device array 210. The fraction of light coupled from the waveguide 201 to the optically active device array 210 may be determined by the design of the photonic device 200 or other device implemented according to embodiments of the present invention.

In alternative embodiments of the present invention, the index of refraction of the substrate 202 is lower than the index of refraction of the lower cladding 204, the waveguide cores 208, and the upper cladding layer 206. In one embodiment, the index of refraction of the waveguide cores 208 is higher than the index of refraction of the upper cladding layer 206 and the lower cladding layer 204. The index of refraction of the upper cladding layer 206 may be similar to the index of refraction of the lower cladding layer 204. The index of refraction of the active regions 212 is normally higher than the index of refraction of the waveguide cores 208 to facilitate reasonably short coupling lengths. In other embodiments of the present invention, a direct bandgap material with a strong absorption for the wavelength of interest is used to make the photonic device compact and reasonably high-speed. The fabrication costs of coupling optically active devices to waveguide arrays are low, particularly when coupling a large number of detector arrays to a large number of waveguide arrays.

FIG. 3 shows an alternative view of the photonic device 200 (not to scale) according to embodiments of the present invention. For example, FIG. 2 shows side view the photonic device 200 and FIG. 3 shows a view along the length of one of the waveguides 201. The longitudinal view of the photonic device 200 shows the set of waveguides 201 and the substrate 202, which includes a lower cladding layer 204 disposed on the substrate 202 (e.g., deposited, formed, grown), the set of waveguide cores 208 (only one is shown) disposed on the lower cladding layer 204, and an upper cladding layer 206 disposed on the set of waveguide cores 208. Some of the upper cladding layer 206 has been removed from the set of waveguides 201 to expose the waveguide cores 208. The optically active device array 210, including the set of optically active devices 214 and the set of active regions 212, may be positioned and aligned such that the active regions 212 are in contact with the exposed waveguide cores 208.

The view shown in FIG. 3 illustrates that the photonic device 200 includes a recess 316 in which the optically active device array 210 sits (as opposed to sitting on a protuberance formed by the upper cladding layer 206 and the core of waveguide 208). The recess 316 may be formed by reducing the thickness of the upper cladding layer 206 on a particular section of the waveguide 208 to expose the core of the waveguide 208. In the embodiment of the present invention shown in FIG. 3, the core of the waveguide 208 is exposed towards the end of the waveguide 208. The dimension of the recess 316 may be fairly tolerant for most applications.

The optically active device array 210 may be placed in the recess 316, aligned to the core of the waveguide 208, and bonded in place, using optically transparent glue and/or flip-chip bonding. There may or may not be an electrical connection between the optically active device array 210 and other portions of the photonic device 200, such as when the photonic device 200 is a passive photonic device. In an alternative embodiment, index of refraction matching fluid may be applied between the optically active device array 210 and the core of the waveguide 208 to enhance coupling efficiency through elimination of a potential thin gap of low refractive index caused by process imperfections

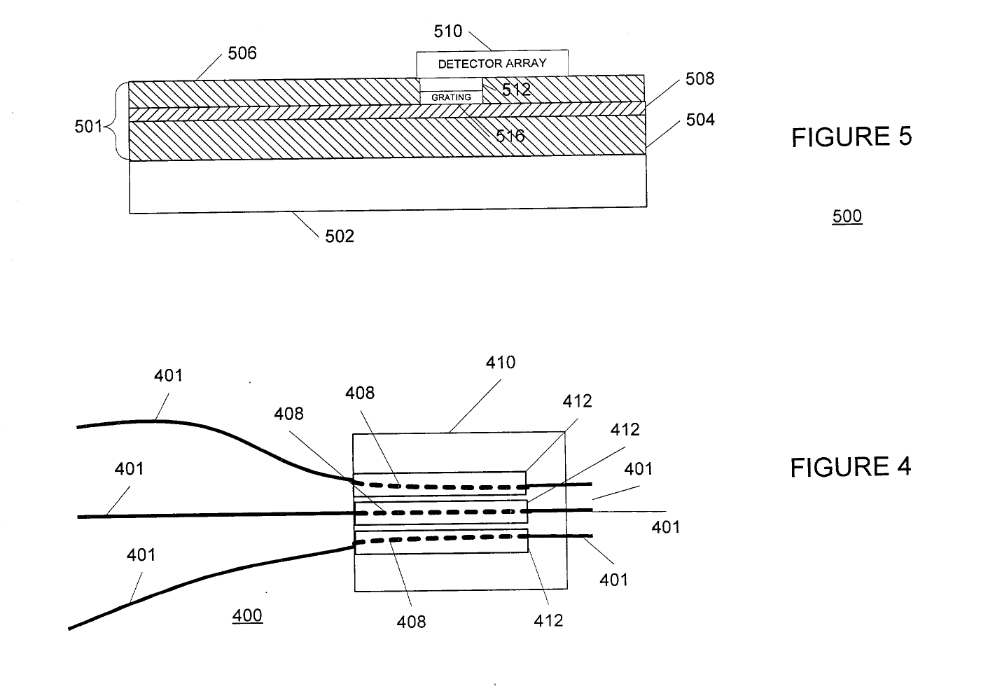

FIG. 4 shows a top view of a photonic device 400 according to an embodiment of the present invention. For example, FIG. 4 shows a set of optically active device arrays 410 active regions 412 in contact with the exposed portions of waveguide cores 408 as well as unexposed (or intact) waveguides 401. In one embodiment of the present invention, the active regions 412 may be 10 μm wide and 500 μm long.

FIG. 5 shows a side view of a photonic device 500 according to embodiments of the present invention. The photonic device 500 is similar to the photonic devices 200 and 300, for example, in that the photonic device 500 includes a set of waveguides 501 (only one is shown) and a substrate 502, which includes a lower cladding layer 504 disposed on the substrate 502, a set of waveguide cores 508 (only one is shown) disposed on the lower cladding layer 504, and an upper cladding layer 506 disposed on the set of waveguide cores 508. A set of gratings 516 may be disposed proximate to the waveguide cores 518. An optically active device array 510 may be placed on top of the gratings 516 either directly or through an intermediate layer 512 of semiconductor material. The gratings 516 may provide enhanced coupling of an optical signal from the waveguide cores 518 to the optically active device array 510. Alternatively, the gratings 516 may provide waveguide selective coupling of an optical signal from the waveguide cores 518 to the optically active device array 510.

The gratings 516 may be used to modify the spectral response of the photonic device 500 by varying the efficiency of the optically active devices in the optically active device array 510, for example, based on wavelength. In one embodiment of the present invention, the set of gratings 516 can be fabricated in the waveguides 501 (e.g., as a photo induced index grating or a Bragg grating). In an alternative embodiment, the set of gratings 516 may be fabricated by etching a corrugation at the interface (i.e., the surface of the of the exposed cores of the waveguides 501) in a manner similar to well-known distributed feedback laser (DFB laser) fabrication techniques. In still other embodiments, the gratings 516 may be second order gratings, which couple light effectively out of the waveguides 501, but other possibilities exist to tune wavelength dependent coupling efficiency.

Note that the direction of light propagation in the waveguide cores 508 is transverse to the longitudinal axis of the gratings 516. In embodiments of the present invention in which the optically active devices are avalanche photodiodes, PIN photodiodes, or other suitable optically active devices, the direction of light propagation in the waveguide cores is along the longitudinal axis of the active regions of the optically active devices.

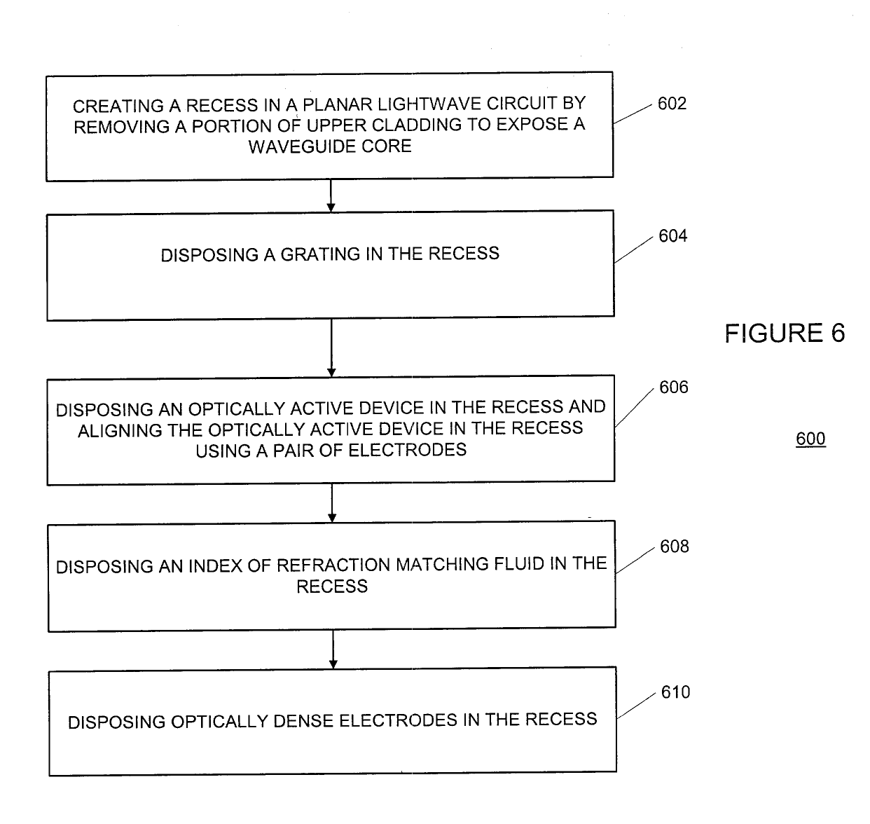

FIG. 6 is a flowchart showing a process 600 for fabricating a photonic device according to embodiment of the present invention. The process 600 may be implemented using standard semiconductor fabrication techniques, such as (plasma-enhanced) chemical vapor deposition, implantation, doping, evaporation, physical vapor deposition, ion assisted deposition, photolithography, magnetron sputtering, electron beam sputtering, diffusion from spin-on solutions, masking, reactive ion etching, and/or other semiconductor fabrication techniques well known to those skilled in the art. A machine-readable medium with machine-readable instructions thereon may be used to cause a processor to perform the process 600. Of course, the process 600 is only an example process and other processes may be used. The order in which they are described should not be construed to imply that these operations are necessarily order-dependent or that the operations be performed in the order in which the blocks are presented.

In block 602, a recess is created in a planar lightwave circuit by removing a portion of upper cladding to expose a waveguide core. In one embodiment of the present invention, a lower cladding layer is formed on a substrate and waveguide channels are formed in the resulting planar lightwave circuit (PLC) platform. The lower cladding layer may be deposited on the substrate using flame hydrolysis. A waveguide pattern may be defined on the platform using any well-known or proprietary photolithographic technique, for example. Selective portions of the lower cladding layer are removed to form waveguide channels, using any well-known or proprietary reactive ion etching technique, for example. The etched portions are smoothed, using well known, or proprietary after-etching techniques, for example. A layer of oxide may be deposited in the waveguide channels, using well known or proprietary plasma enhanced chemical vapor deposition (PECVD) techniques, for example. Windows may be opened in the oxide layer for phosphorous implantation, phosphorous may be implanted in the waveguide channels through the windows, and the waveguide channels may be wet etched to remove PECVD oxide.

A waveguide core layer may be formed on the lower cladding layer. In one embodiment, a layer of oxide may be deposited in the waveguide channels, using well known or proprietary plasma enhanced chemical vapor deposition (PECVD) techniques, for example. Windows may be opened in the oxide layer for implantation of boron, silica, germanium, erbium, and/or other suitable waveguide core material, and the waveguide core material may be implanted in the waveguide channels through the windows. The waveguide channels may be wet etched to remove PECVD oxide. The waveguide cores may be annealed to activate the implants.

An upper cladding layer may be formed on the waveguide core layer. In one embodiment, the upper cladding layer is deposited on the waveguide cores using flame hydrolysis. A portion of the upper cladding layer may be removed to expose selective portions of the waveguide core layer. In one embodiment, the upper cladding layer is removed from the ends of the waveguides (e.g., channels filled with core material and layered with cladding) using reactive ion etching.

In block 604, a grating may be disposed in the recess. In embodiments of the present invention, a photo induced index grating or a Bragg grating may be disposed in the recess. In an alternative embodiment, a grating fabricated by etching a corrugation at the interface (i.e., the surface of the of the exposed waveguide core) in a manner similar to well known distributed feedback laser (DFB laser) fabrication techniques. In still other embodiments, a second order grating may be disposed in the recess.

In block 606, an optically active device may be disposed in the recess and aligned using electrodes. In a block 608, an index of refraction matching fluid may be disposed in the recess.

In a block 610, second set of recesses may be formed in the planar lightwave circuit by removing a portion of upper cladding to expose a second set of waveguide cores, a second set of gratings is disposed in the second set of recesses, a second set of optically active devices may be disposed in the a second set of recesses, and optically dense electrodes may be disposed in the recesses to reduce cross-talk between neighboring optically active devices and/or between neighboring waveguide cores. An active material may be disposed in the recess on top of or in close proximity to the exposed portions of the waveguide cores. In one embodiment, the active material may be sandwiched between an optically active device and the exposed portions of the waveguide cores.

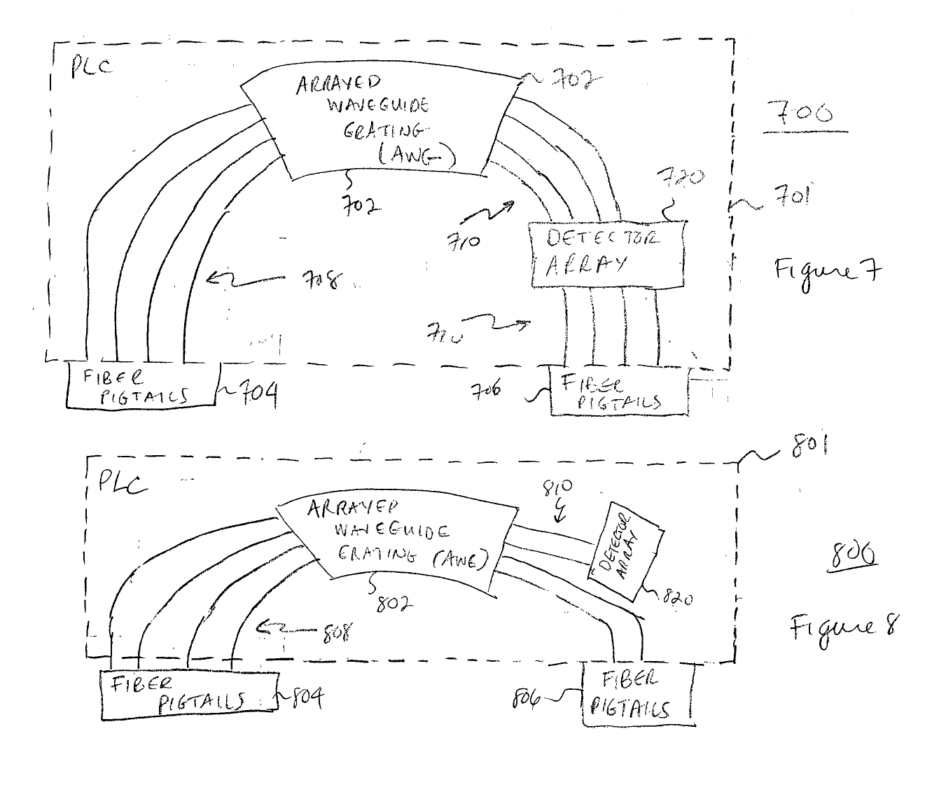

FIG. 7 is a schematic diagram of an optical system 700 according to embodiments of the present invention. The optical system 700 includes a planar lightwave circuit (PLC) 701 and two sets of fiber pigtails 704 and 706. The planar lightwave circuit (PLC) 701 includes an arrayed waveguide grating (AWG) 702 and two sets of waveguides 708 and 710. The set of waveguides 708 is coupled to the fiber pigtails 704. An optically active device array 720 is coupled between the AWG 702 and the fiber pigtails 706 in accordance with embodiments of the present invention in that the cores of a portion of the waveguides 710 have been exposed so that the active regions of the detectors in the detector array 720 absorbs light from the cores of the waveguides 710.

In the embodiment shown in FIG. 7, each channel in/out of the AWG 702 has a portion of its data stream absorbed by the optically active device array 720 before/after the optical signal is passed to/from the AWG 702 from/to the fiber pigtails 706. Note that systems, such as the embodiment illustrated in FIG. 7, channels being monitored may be read without fiber interfacing or consumption of PLC edge area.

FIG. 8 is a schematic diagram of an optical system 800 according to alternative embodiments of the present invention. The optical system 800 includes a planar lightwave circuit (PLC) 801 and two sets of fiber pigtails 804 and 806. The planar lightwave circuit (PLC) 801 includes an arrayed waveguide grating (AWG) 802 and two sets of waveguides 808 and 810. The set of waveguides 808 is coupled to the fiber pigtails 804. An optically active device array 820 is coupled after the AWG 802 terminating the light path in accordance with embodiments of the present invention in that the cores of a portion of the waveguides 810 have been exposed so that the active regions of the detectors in the optically active device array 820 absorbs light from the active regions.

In the embodiment shown in FIG. 8, a subset of channels in/out of the AWG 802 has a portion of the data stream absorbed by the optically active device array 820 before/after the optical signal is passed to/from the AWG 802 from/to the fiber pigtails 806. Although two channels are shown in FIG. 8, the subset of channels may be one or more channels. Note that in complex monitored system, such as the embodiment illustrated in FIG. 8, monitoring of the data stream can be added at moderate cost, using the detector array 820 as one or more add/drop nodes.

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
a planar lightwave circuit having a set of recesses formed to expose waveguide cores; and
a set of optically active devices disposed in the recesses proximate to the waveguide cores.

2. The apparatus of claim 1, further comprising electrodes coupled to align the optically active devices in the recesses.

3. The apparatus of claim 2, wherein the electrodes are optically dense to reduce crosstalk between neighboring exposed waveguide cores.

4. The apparatus of claim 3, wherein the electrodes are optically dense to reduce crosstalk between neighboring optically active devices.

5. The apparatus of claim 1, wherein each optically active device includes an active region, the active regions having an index of refraction higher than an index of refraction of the waveguide cores.

6. The apparatus of claim 4, further comprising a set of gratings disposed in the recesses proximate to the exposed waveguide cores.

7. The apparatus of claim 1, wherein a length of the active regions is sufficiently large to detect a substantial portion of an optical signal propagating in the waveguide cores.

8. The apparatus of claim 5, wherein the active region includes semiconductor material.

9. The apparatus of claim 1, wherein the waveguide cores include nitrogen.

10. The apparatus of claim 6, wherein the gratings are photo-induced index gratings.

11. The apparatus of claim 1, wherein the gratings are etched gratings.

12. The apparatus of claim 5, further comprising index of refraction matching fluid disposed between the optically active devices and the waveguide cores.

13. The apparatus of claim 1, wherein the planar lightwave circuit is at least one of a silica-on-insulator (SOI) planar lightwave circuit, a lithium niobate (LiNbO₃) planar lightwave circuit, an indium phosphide (InP) planar lightwave circuit, or a gallium arsenide (GaAs) planar lightwave circuit.

14. The apparatus of claim 1, wherein the optically active device includes at least one of an avalanche photodiode (APD), a PIN photodiode, or a photoconductor.

15. A method of making a photonic device, comprising:
creating a recess in a planar lightwave circuit by removing a portion of upper cladding to expose a waveguide core; and
disposing an optically active device in the recess.

16. The method of claim 15, further comprising disposing an index of refraction matching fluid in the recess.

17. The method of claim 16, further comprising aligning the optically active device in the recess using a pair of electrodes.

18. The method of claim 17, further comprising:
creating a second set of recesses in the planar lightwave circuit by removing a portion of upper cladding to expose a second set of waveguide cores; and
disposing a second set of optically active devices in the a second set of recesses; and
disposing optically dense electrodes in the first and second set of recesses to reduce crosstalk between neighboring waveguides cores.

19. The method of claim 17, further comprising disposing optically dense electrodes in the recess to reduce cross-talk between neighboring optically active devices.

20. The method of claim 1, wherein the optically active devices are disposed in the recesses proximate to the waveguide cores away from edges of the planar lightwave circuit.

21. A system, comprising:
a planar lightwave circuit (PLC) having a set of recesses formed to expose waveguide cores and a set of optically active devices disposed in the recesses proximate to the waveguide cores; and
a set of optical fiber pigtails coupled to the planar lightwave circuit (PLC).

22. The system of claim 21, further comprising a set of gratings disposed in the recesses proximate to the waveguide cores.

23. The system of claim 21, wherein the gratings are etched gratings or photo-induced gratings.

24. The system of claim 22, further comprising an index of refraction matching fluid disposed in the recess.

25. The system of claim 23, wherein the planar lightwave circuit comprises at least one of a silica-on-silicon planar lightwave circuit, a lithium niobate (LiNbO₃) planar lightwave circuit, a gallium arsenide (GaAs) planar lightwave circuit, an indium phosphide (InP) planar lightwave circuit, a silicon-on-insulator (SOI) planar lightwave circuit, a silicon oxynitride (SiON) planar lightwave circuit, a polymer planar lightwave circuit.

26. A method, comprising:
propagating light through a set of waveguide cores in a set of recesses in a planar lightwave circuit; and
coupling a portion of the light from the waveguide cores into a set of optically active devices disposed in the recesses.

27. The method of claim 26, further comprising masking cross-talk between waveguide cores using a set of optically dense electrodes.

28. The method of claim 26, further comprising masking cross-talk between optically active devices using a set of optically dense electrodes.

29. The method of claim 26, further comprising coupling a portion of the light from the waveguide cores into a set of gratings disposed in the recess.
